(19) United States
(12) Patent Application Publication
(10) Pub. No.: US 2026/0094463 A1
(43) Pub. Date: Apr. 2, 2026

(54) EFFICIENT DATASET GENERATION FOR DOCUMENT UNDERSTANDING

(71) Applicant: Dell Products L.P., Round Rock, TX (US)

(72) Inventors: Paulo Abelha Ferreira, Rio de Janeiro (BR); Pablo Nascimento da Silva, Niterói (BR); Vinicius Michel Gottin, Rio de Janeiro (BR); Iam Palatnik de Sousa, Rio de Janeiro (BR)

(21) Appl. No.: 18/899,048

(22) Filed: Sep. 27, 2024

(51) Int. Cl. G06V 30/19; G06F 40/109; G06F 40/186; G06F 40/40; G06V 30/41

(52) U.S. Cl. CPC G06V 30/19147; G06F 40/109; G06F 40/186; G06F 40/40; G06V 30/41

(57) ABSTRACT

Generating synthetic documents for training document understanding models is disclosed. Document templates are used to generate synthetic documents and corresponding labels, which are used to train a document understanding model. The document template is filled by determining values for the fields of the documents. Noise is introduced into the synthetic documents by varying the placement of values within the fields and changing font/font types. The synthetic documents may be used to fine-tune models. The models can perform multiple tasks such as answering questions, classification, and parsing.

### TECHNOLOGICAL FIELD OF THE DISCLOSURE

Embodiments disclosed herein generally relate to document understanding. More particularly, at least some embodiments relate to systems, hardware, software, computer-readable media, and methods for generating synthetic documents for training models configured for document understanding.

### BACKGROUND

Document understanding generally relates to the process of extracting data from documents (e.g., scans of documents) using artificial intelligence/machine learning models (AI/ML). Even assuming that some solutions to this problem exist, these solutions face many challenges including high data and resource requirements. In addition, these solutions are costly.

Once of the challenges facing document understanding systems relates to training a document understanding model. Small models, for example, consume fewer resources and are less costly than larger models. However, smaller models cannot generalize as well as comparatively larger models. One potential solution to this problem is to acquire a good dataset to train the smaller model. Building this type of dataset, however, requires human labelers. Thus, this option is cost prohibitive and inefficient for generating novel and valuable versions of a training dataset.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a real-world document and also illustrates an example of a document template;

FIG. 2 discloses aspects of an example of a warehouse and transport management system;

FIG. 3 discloses aspects of a pipeline or method for generating synthetic documents based on document templates;

FIG. 4 discloses additional aspects of a computing system configured to generate synthetic documents based on document templates;

FIG. 5 discloses aspects of performing document understanding using a model trained on synthetic documents; and

FIG. 6 discloses aspects of a computing device, system, and/or entity.

### DETAILED DESCRIPTION OF SOME EXAMPLE EMBODIMENTS

Embodiments disclosed herein generally relate to document understanding. More particularly, at least some embodiments relate to systems, hardware, software, computer-readable media, and methods for generating datasets configured for training models. These datasets include synthetic documents (e.g., document images) that are appropriately labeled. Embodiments of the invention further relate to automatically extracting and/or processing data contained in real-world documents or images thereof.

Embodiments of the invention can be adapted to or generalized to a wide variety document types. Embodiments include document types such legal documents, business documents, educational documents, informational documents, or the like or combinations thereof. In the context of warehouses and warehouse management, various types of documents may be used such as purchase orders, invoices, contracts, statements, or the like.

Embodiments of the invention are discussed in the context of shipping documents including bills of lading (BoLs). However, embodiments of the invention may be applied or adapted to other document types.

To automate various warehouse operations (e.g., inventory related operations, product placement operations, accounting related operations), it may be necessary to automate document processing operations. Thus, embodiments of the invention relate to document understanding, which generally relates to operations for extracting data from various types of documents such as BoLs. Although reference is made to documents, it is understood that many operations disclosed herein operate on images (e.g., scanned images) of documents. For instance, when a package is received, the BoL is scanned and the document (scanned image) is subject to document understanding related operations.

Embodiments of the invention are configured to generate large amounts of synthetic labeled data (e.g., synthetic documents) for document understanding purposes such as training a document understanding model. Generating synthetic labeled data may include generating a collection or set of documents from various document templates without human intervention, by filling a document template with correct or useful information. The generated documents are labeled. In some examples, noisy documents are generated to better simulate real world data or documents.

Embodiments of the invention relate to a document generation engine configured to generate synthetic documents, which may be labeled and/or noisy. In order to generate synthetic documents, in one example, a set of document templates may be defined. Each of the document templates includes field and value pairs. The locations of each of the pairs is also defined in the document templates. The document generation engine may generate data to populate these fields with valid data. The synthetic documents may be used exclusively and/or with real world documents to train the model.

Embodiments of the invention are discussed in the context of shipping documents including bills of lading (BoLs). However, embodiments of the invention may adapt to other document types and/or be capable of handling multiple types of documents. Because organizations may use different formats/sizes for the same document, the synthetic documents generated for training purposes may similarly vary in format/size. Further, noise may be introduced into the synthetic documents. Noise may relate to font (e.g., using different fonts), font size, position on document, or the like. Additional noise to reflect discontinuities (e.g., tears in the document) or other noise to reflect dirt, rotated documents, or other factors that may impede document understanding may also be introduced.

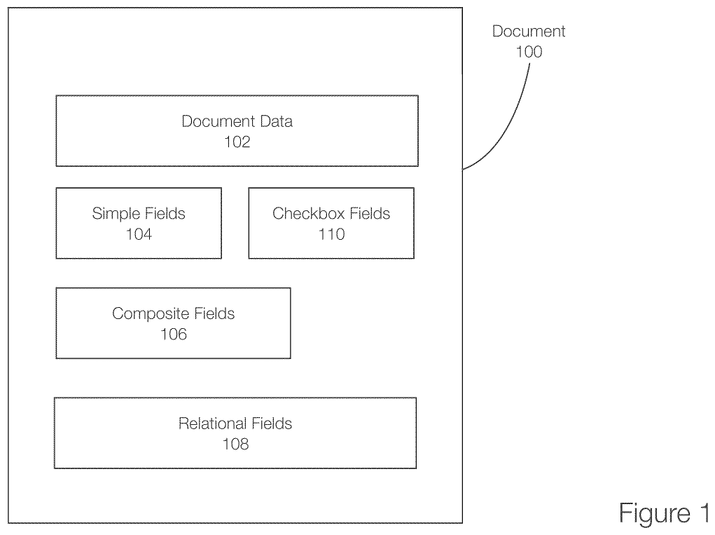

FIG. 1 discloses aspects of a document. The document 100 is an example of a bill of lading and is used to represent both a real-world document and a document template.

When the document 100 represents a real-world document, the document 100 may include document data 102. The document data 102 may represent data that does not necessarily need to be extracted or interpreted. For instance, the document data 102 may include company name, graphics, lines, or the like. The document 100 may include fields of various types, which are represented by simple fields 104, composite fields 106, relationship fields 108, and checkbox fields. The document 100 is presented by way of example and the number and type of fields may vary and/or differ from the document 100.

The fields 104, 106, 108, and 110 are described by way of example and not limitation. The simple fields 100 may represent data or information such as name, state, country, or the like. The composite fields 106 may represent data or information that may convey different data. For example, a composite field may represent one or more of store, department, street, apartment, division or the like or combinations thereof.

The relationship fields 108 may be used to represent data that may be presented in table form. For example, a table may represent related information such as unit, quantity, description, weight, item number, or the like or combinations thereof.

The checkbox fields 110 may be used to represent data that is present/not present, true/not true, a specific choice, or the like. For example, checkbox fields may be used to represent service type (e.g., priority, economy).

When considering the document 100 as a document template, embodiments of the invention overcome challenges associated with generating a collection of synthetic documents from different templates without human intervention, filling out a template with valid, usable and/or correct information, and/or generating noisy documents to simulate real world data.

If the document is viewed as a document template, the fields and their positions are typically defined. The size and format of the document 100 may also be defined. When generating a synthetic document from the document 100, the fields (or a portion of the fields) may be filled with data and a label is generated. The generated may be generated using large language models, by functions, or retrieved from a source in some examples.

For instance, a name field may be filled with “John Q. Public” and the corresponding label indicates that the name field is populated with the data “John Q. Public”. Other fields are similarly filled and represented in the label. The label for the synthetic document provides ground truth information and may be used during training. As previously indicated, the synthetic document may be an image. Thus, an image of a document is ultimately generated from the document template.

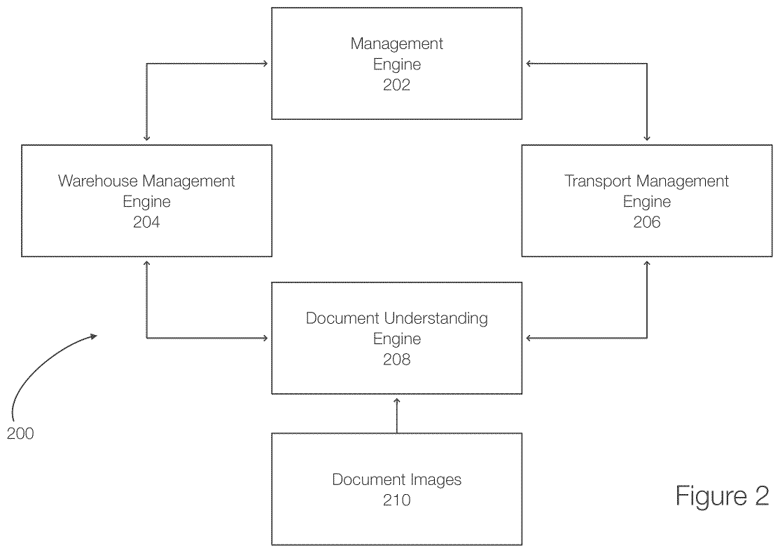

FIG. 2 discloses aspects of an automated warehouse and transport management system. In this example, the automated warehouse and transport management system (system 200) includes a management engine 202, a warehouse management engine 204, and a transport management engine 206. The management engine 202 may perform or manage functions/operations such as accounting, invoicing, order management, inventory management, and the like. The warehouse management engine 204 may perform or manage functions/operations such as order picking and fulfillment, inventory tracking, shipping and receiving, labor management, and the like. The transport management engine 206 may perform or manage functions/operations such as freight management, carrier ratings, route, mode, and/or carrier optimization, or the like.

For example, the warehouse management engine 204 may provide data such as inventory updates and order status to the management engine 202. The management engine 202 may provide orders, inventory synchronization reports, and the like to the warehouse management engine 204. The management engine 202 may provide orders, item and customer information to the transport management engine 206 and the transport management engine 206 may provide shipment information such as tracking number, carrier, location, cost, and the like to the management engine 202.

The operations performed by the management engine 202, the warehouse management engine 204, and the transport management engine 206 may rely on data extracted from documents by the document understanding engine 208. In this example, the document understanding engine 208 is an example of or includes a model trained to process documents such as bills of lading and/or extract data from the documents.

Thus, document images 210 from incoming/outgoing shipments may be scanned and input to the document understanding engine 208. The data extracted from the document images 210 may be provided to the system 200 and more specifically to the warehouse management engine 204 and the transport management engine 206 in one example.

The document understanding engine 208 may include multiple models including, by way of example, an extractive model, an abstractive model, and a zero-shot model. An extractive model is typically configured to extract information from the document images. An extractive model may be used to answer various questions such as “how many units of product X are in the shipment?”. Thus, the document understanding model 208 may be able to answer questions using the information extracted from the document images 210.

An abstractive model may be configured to summarize or provide the information in the document images 210 in a different manner. This is distinct from extracting data and allows the document to be, in one example, summarized.

A zero-shot model may be configured to identify relationships between various fields that facilitate the performance of downstream tasks. A zero-shot model may also be configured to perform classifications or the like. Thus, the document can be classified.

Based on an input document, the document understanding engine 208 may determine that a package requires a special skid or handling based on the description, or determine that the package contains hazardous materials and map to a hazard classification system. The document understanding engine 208 may be able to identify that the contents of the documents are consistent or inconsistent. For example, the weight/dimensions measured by a carrier may differ from those in the document.

The ability to efficiently understand document in an automated manner (e.g., without user input) allows packages to be managed more efficiently, quickly, and effectively. Document understanding also allows discrepancies or errors to be addressed efficiently.

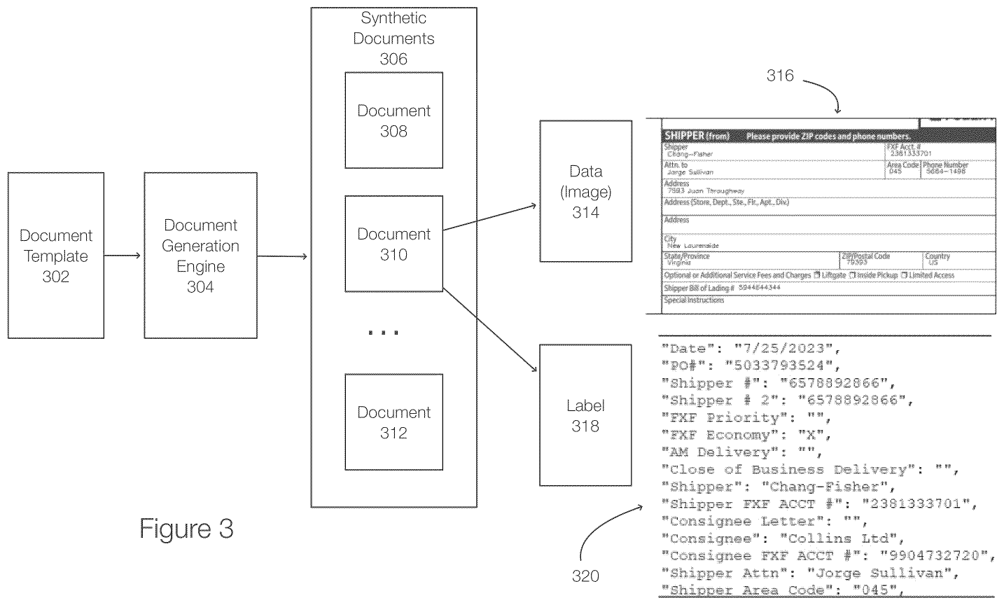

FIG. 3 discloses aspects of generating synthetic data such as synthetic documents. FIG. 3 further illustrates an architecture or framework for generating large amounts of varied document data starting from a single document template. Embodiments of the invention may generate large amounts of varied synthetic documents for multiple templates. Using multiple document templates ensures that the synthetic dataset is diverse. This improves training and allows for a more generalized trained model.

As previously stated, embodiments of the invention generate synthetic documents for training models such as large language models. The trained models are capable on consuming a scanned image of a document. Prompts may also be used such that the trained model may generate answers from the scanned or image documents for automated processing.

In FIG. 3, a document template 302 is generated or retrieved from a template library. The document template 302 may include fields that are defined and whose positions in the document are known. The definition may include various metadata such as size, type, and the like. The document generation engine 304 generates synthetic documents 306 from the document template 302, represented by the synthetic documents 308, 310, and 312. More specifically, the document generation engine 304 generates/retrieves data to include in the fields of the document template 302. The data or information placed in the fields may be retrieved from one or more sources or libraries, generated by large language models, or the like, and may be subject to various constraints.

The document generation engine 304 may also generate the synthetic documents 306 such that at least some of the synthetic documents 306 are noisy. Noise may be introduced by rotating the document, changing font/font size, changing the positions of the data within the fields (or placing data on field borders), and the like. The synthetic documents may also be blurred, darkened, dirtied, or the like.

When completed, the synthetic document includes data (e.g., field values) and a label. The document 310, for example, includes data 314 (a document image 316) and a label 318. The document 310 may also be associated with metadata (e.g., position of fields in the document template 302). The data 314 may be an image 318 of the document 310. The label 318 includes ground truth 320. The labels of the synthetic documents allow errors of the model to be identified and corrected during training.

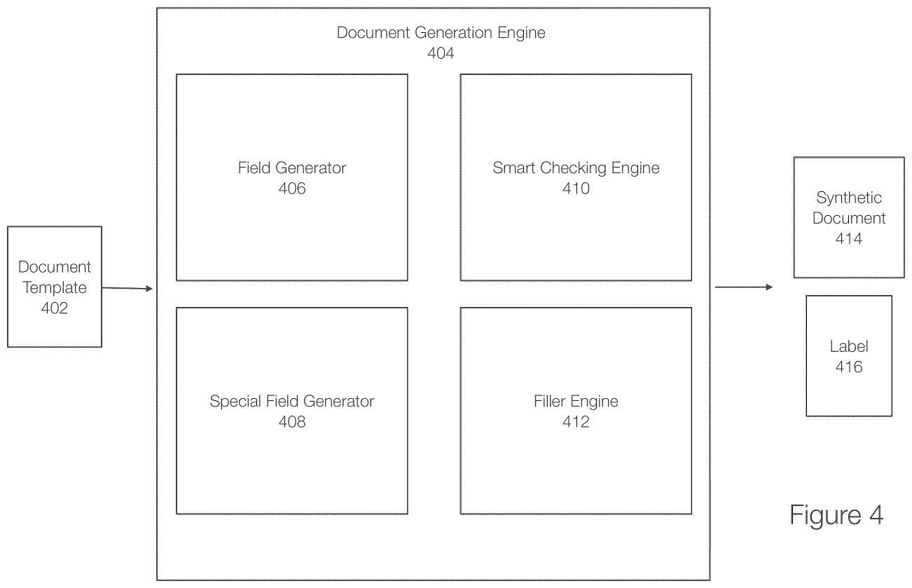

FIG. 4 discloses aspects of a document generation engine configured to generate synthetic documents that may be used, in one example, for training a model. In FIG. 4, the document generation engine 404 receives or selects a document template 402. The document generation engine 404 processes the document template 402 to identify all fields to be filled. The positions of the fields are also determined or retrieved.

The document generation engine 404 generates or creates strings (or other data type) for each field and fills out each of the fields in the correct position (or a noisy position). For example, a probabilistic position may be used when filling out the fields such that values are not always filled out or placed at the same position with respect to a field. In addition, the font type and size may be varied. All field types are also classified as simple fields, checkbox fields, composite fields, or relational fields in one example. In one example, composite fields are treated as simple fields.

The field generator 406 may use open-source libraries to generate values for a variety of different fields. The field generator 406 may specify features for the various field types. For example, the field generator 406 may specify features such as minimum and maximum length of strings, regular expression patterns, dictionaries, and the like. For instance, a purchase order number may follow a particular regular expression. States and countries may have or be associated with a fixed set of possible values.

The smart checking engine 410 is configured to fill checkbox field values. In one example, a probability distribution for each type of checkbox field in the document template may be determined or used. The type of ticker character (e.g., an “x” or a checkmark (“✓”) and its positioning are also taken or selected from a set of font types and sizes. The positioning of the ticker character is also done using the probabilistic positioner.

The special field generator 408 is configured for handling relational fields such as tables. One example of relational fields is the delivery items in a bill of lading document. The special field generator 408 may use a large language model to generate constrained tuples of relational field values. For instance, in the context of a bill of lading document, the large language model may be configured to generate item types and constrain the item types to be in a reasonable real-world range of values (e.g., weight, number, size). The large language model may also classify the item type as hazardous or not (HM for Hazard Material). As part of the tuple, numerical quantities such as number of units of a given item may be included. Additionally, as part of the last item in a table, a totalization field may be included. In this case, all constrained tuples generated by the LLM are selected and, for each numerical quantity, the total is calculated, so that the totalization field value can be filled out correctly. Like other fields, the special field generator may vary font type and size and may use and the probabilistic positioner when filling the relational field.

The filler engine 412 is configured to collect all the data collected from the field generator 406, the smart checking engine 410, and the special field generator 408 and fill an instance of the document template 402 with the data or values.

An image is then instantiated from the completed and filled document template 402. This may include convert each generated field value into an image value. The positioning data is used to place the image values in the instantiated image. The document generation engine 404 then generates a document image from a given document template 402 filled with data and a file (e.g., a JSON file) containing structured labeling for all of the fields. Thus, the synthetic document 414 is an example of the document image generated by the document generation engine 404 and is associated with a label 416. The synthetic document 414 is used as training data for a model and the structured label 416 as ground truth for training. The document generation engine 404 may execute a large number of times (n times) using one or more document templates to generate a training dataset of labeled synthetic documents. During training the training dataset may split into a training dataset and a validation dataset.

The document generation engine 404 is an example of a framework for building a dataset with semantic coherence in data generation without human intervention. The document generation engine 404 may implement a method for intelligently filling out document templates of documents based on LLM, which is prompted to generate semantically rich constrained tuples for relational fields, and may implement a method for programmatically generating constrained diversity in a variety of different classes of fields.

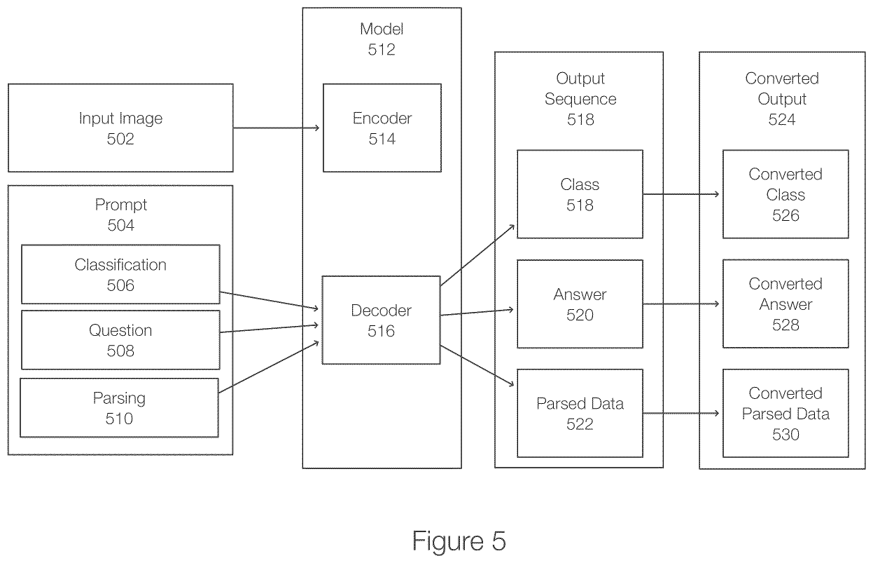

FIG. 5 discloses aspects of operating a model trained on synthetic data for document understanding. FIG. 5 illustrates a model 512 that includes an encoder 514 and a decoder 514. The model 512 is trained using large amounts of synthetic labeled documents and is configured to recover/extract information based on an input that includes an image 502 and/or a prompt 504. The input image 502 may be an image of a document such as a bill of lading.

The model 512 is a multi-task multimodal large language model in one example and is configured to respond to different promptings for an input image 502. In this example, the model 512 is configured to response to a classification prompt 506, a question (e.g., open ended question) prompt 508, and a parsing prompt 510. In other words, the model 512 may perform multiple tasks (3 in this example). Further, for the model 512 to operate efficiently with respect to a new set of documents, the model 512 may be fine-tuned using data from that document type. Thus, synthetic documents may be generated from a document template for that type.

The output sequence 518 of the model 512 includes a response for each task. The model 512 may generate a class 518, an answer 520 to the question 508, and parsed data 522. The converted output 524 may convert the output sequence 518 to a particular format (e.g., JSON format). Thus, the class 518, the answer 520, and the parsed data 522 become, respectively a converted class 526, a converted answer 528, and a converted parsed data 530.

For example, the question 508, answer 520, and converted answer 528 may be represented as follows:
question 508
<vqa><question>what is the price of choco mochi?</question><answer>
answer 520
14,000</answer><</vqa>
converted answer 528
{“question”: “what is the price of choco mochi?”,“answer”: “14,000”}.

The converted output 524 may have a standard that can be read and interpreted by the associated management system.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, training operations, synthetic document generation operations, noise generation operations, document understanding and related operations, warehouse management operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: (a) selecting a document template, wherein the document template is associated with fields and positions of the fields within the document template, (b) determining values for each of the fields in the document template, (c) filling the fields in the document template with the determined values to generate a filled document template, and (d)generating a synthetic document from the filled document template, wherein the synthetic document includes an image of the filled document template and a label that includes ground truth for each of the filled fields.

Embodiment 2. The method of embodiment 1, wherein the document template is selected from a library of document templates.

Embodiment 3. The method of embodiment 1 and/or 2, wherein the fields include simple fields, checkbox fields, and/or relational fields.

Embodiment 4. The method of embodiment 1, 2, and/or 3, further comprising determining positions of each of the fields in the document template.

Embodiment 5. The method of embodiment 1, 2, 3, and/or 4, further comprising performing (b), (c), and (d) n times for each of a plurality of document templates to generate synthetic documents for each of the plurality of document templates, wherein a font type and a font size are varied among the synthetic documents.

Embodiment 6. The method of embodiment 1, 2, 3, 4, and/or 5, further comprising varying a position of the determined values within the corresponding fields based on a probabilistic positioner.

Embodiment 7. The method of embodiment 1, 2, 3, 4, 5, and/or 6, further comprising generating values for the relational fields using a large language model, wherein the values for the relational fields are constrained to real-world ranges.

Embodiment 8. The method of embodiment 1, 2, 3, 4, 5, 6, and/or 7, further comprising determining totals for numerical quantities in the relational fields.

Embodiment 9. The method of embodiment 1, 2, 3, 4, 5, 6, 7, and/or 8, further comprising training a model using the synthetic documents.

Embodiment 10. A system, comprising hardware and/or software, operable to perform any of the operations, methods, or processes, or any portion of any of these, disclosed herein.

Embodiment 11. A non-transitory storage medium having stored therein instructions that are executable by one or more hardware processors to perform operations comprising the operations of any one or more of embodiments 1-9.

Embodiment 12. A computing system comprising a processor and configured to generate synthetic documents that each include an image of a document and a corresponding label, the computing system comprising a document generation engine that includes: a field generator configured to generate values for fields of a document template using source, functions, and/or large language models, wherein the field generator varies font type, font size and positions of the values when the values are inserted into the fields, wherein the document template defines the fields and positions of the fields, the fields including simple fields, checkbox fields, and relational fields, a smart checking engine configured to fill out the checkbox fields using a probability distribution, wherein a ticker character for filling the checkbox fields is varied in font type, font size and position within the checkbox fields, a special field generator configured to generate relational field values for the relational fields using a large language model, wherein the relational field values are constrained tuples according to real-world ranges, a filler engine configured to collect data generated by the field generator, the smart checking engine, and the special field generate to fill an instance of the document template, wherein the document generation engine outputs the synthetic documents.

Embodiment 13. The computing system of claim 12, wherein the synthetic documents are configured for fine-tuning a model configured to perform multiple tasks on input images of real world documents, the tasks including classification of the images, generating an answer to a question regarding the real world documents, and parsing the content of the real world documents.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

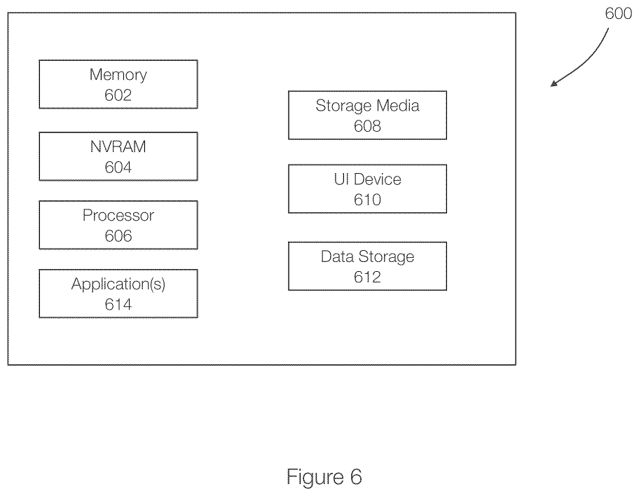

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

The device 600 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 600 may also represent a physical or virtual machine or server, an edge-based computing system, a cloud-based computing system, server clusters or other computing systems or environments. The device 600 may also represent multiple machines or devices, whether virtual, containerized, or physical. The device 600 may perform or execute steps or acts of the methods illustrated in the Figures.

The device 600 may represent a cloud-based system, an edge-based, system, an on-premise system, or combinations thereof. Document understanding and related operations may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method comprising:
(a) selecting a document template, wherein the document template is associated with fields and positions of the fields within the document template;
(b) determining values for each of the fields in the document template;
(c) filling the fields in the document template with the determined values to generate a filled document template; and
(d) generating a synthetic document from the filled document template, wherein the synthetic document includes an image of the filled document template and a label that includes ground truth for each of the filled fields.

2. The method of claim 1, wherein the document template is selected from a library of document templates.

3. The method of claim 1, wherein the fields include simple fields, checkbox fields, and/or relational fields.

4. The method of claim 3, further comprising determining positions of each of the fields in the document template.

5. The method of claim 4, further comprising performing (b), (c), and (d) n times for each of a plurality of document templates to generate synthetic documents for each of the plurality of document templates, wherein a font type and a font size are varied among the synthetic documents.

6. The method of claim 5, further comprising varying a position of the determined values within the corresponding fields based on a probabilistic positioner.

7. The method of claim 6, further comprising generating values for the relational fields using a large language model, wherein the values for the relational fields are constrained to real-world ranges.

8. The method of claim 7, further comprising determining totals for numerical quantities in the relational fields.

9. The method of claim 7, further comprising training a model using the synthetic documents.

10. A non-transitory storage medium having stored therein instructions that are executable by one or more hardware processors to perform operations comprising:
(a) selecting a document template, wherein the document template is associated with fields and positions of the fields within the document template;
(b) determining values for each of the fields in the document template;
(c) filling the fields in the document template with the determined values to generate a filled document template; and
(d) generating a synthetic document from the filled document template, wherein the synthetic document includes an image of the filled document template and a label that includes ground truth for each of the filled fields.

11. The non-transitory storage medium of claim 10, wherein the document template is selected from a library of document templates.

12. The non-transitory storage medium of claim 10, wherein the fields include simple fields, checkbox fields, and/or relational fields.

13. The non-transitory storage medium of claim 12, further comprising determining positions of each of the fields in the document template.

14. The non-transitory storage medium of claim 13, further comprising performing (b), (c), and (d) n times for each of a plurality of document templates to generate synthetic documents for each of the plurality of document templates, wherein a font type and a font size are varied among the synthetic documents.

15. The non-transitory storage medium of claim 14, further comprising varying a position of the determined values within the corresponding fields based on a probabilistic positioner.

16. The non-transitory storage medium of claim 15, further comprising generating values for the relational fields using a large language model, wherein the values for the relational fields are constrained to real-world ranges.

17. The non-transitory storage medium of claim 16, further comprising determining totals for numerical quantities in the relational fields.

18. The non-transitory storage medium of claim 16, further comprising training a model using the synthetic documents.

19. A computing system comprising a processor and configured to generate synthetic documents that each include an image of a document and a corresponding label, the computing system comprising a document generation engine that includes:
a field generator configured to generate values for fields of a document template using source, functions, and/or large language models, wherein the field generator varies font type, font size and positions of the values when the values are inserted into the fields, wherein the document template defines the fields and positions of the fields, the fields including simple fields, checkbox fields, and relational fields;
a smart checking engine configured to fill out the checkbox fields using a probability distribution, wherein a ticker character for filling the checkbox fields is varied in font type, font size and position within the checkbox fields;
a special field generator configured to generate relational field values for the relational fields using a large language model, wherein the relational field values are constrained tuples according to real-world ranges;
a filler engine configured to collect data generated by the field generator, the smart checking engine, and the special field generate to fill an instance of the document template,
wherein the document generation engine outputs the synthetic documents.

20. The computing system of claim 19, wherein the synthetic documents are configured for fine-tuning a model configured to perform multiple tasks on input images of real world documents, the tasks including classification of the images, generating an answer to a question regarding the real world documents, and parsing the content of the real world documents.
